(19) United States
(12) Patent Application Publication
(10) Pub. No.: US 2026/0113235 A1
(43) Pub. Date: Apr. 23, 2026

(54) HOST TO STORAGE PATH LOSS DETECTION

(71) Applicant: Dell Products L.P., Round Rock, TX (US)

(72) Inventors: Scott Rowlands, Cumming, GA (US); Krishna Deepak Nuthakki, Bangalore (IN); Arieh Don, Newton, MA (US)

(73) Assignee: Dell Products L.P., Round Rock, TX (US)

(21) Appl. No.: 18/919,575

(22) Filed: Oct. 18, 2024

(51) Int. Cl. H04L 41/0604; H04L 41/0631; H04L 67/1097

(52) U.S. Cl. CPC H04L 41/0622; H04L 41/0631; H04L 67/1097

(57) ABSTRACT

Systems and methods for detecting a path loss between a host and a storage array are disclosed. A storage array connected to a host over a network identifies the host and a link-alive command. A first link-alive command is received from the host, followed by a second link-alive command. A first period is measured between the first and subsequent link-alive commands. A path error is determined if a second time between two subsequent link-alive commands exceeds a threshold based on the first period and an alert is issued.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

Host systems and their applications communicate over a network to the distributed storage systems. While the host systems are configured to periodically test and determine if communication paths between the host and the storage system are valid and working properly, that is not the case for the storage array. Known host operating systems and/or multiport input/output (MPIO) drivers leverage small computer system interface (SCSI) commands to determine whether a path between the storage array and the host is still valid, i.e., “link-alive detection”. The operating system or the MPIO drivers send these commands in fixed, user-defined intervals to validate the path viability. The viability of the communications paths is unknown to the storage system and as such, a user, administrator, or monitor of the storage system is not readily aware of a connectivity loss, such as a switch failure, host bus adapter failure, cable failure, OS crash or the like.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect, a method may include providing a storage array having one or more communication paths over a network to a host and determining by the storage array a link-alive command associated with the host. The storage array may detect a first link-alive command from the host and a second link-alive command from the host. The storage array may measure a first period between the first and second link-alive commands and define a monitoring threshold based on the first period. The storage array may determine a path error if a second period between two subsequent link-alive commands exceeds the monitoring threshold.

The method may include, alone or in combination, one or more of the following features. Determining the link-alive command may include determining an operating system of the host. Determining the link-alive command may include receiving fabric device management interface (FDMI) data from a switch on the one or more communication paths. The link-alive command may be at least one of an inquiry command or a test unit ready (TUR) command. An alert may be generated when the second period exceeds the monitoring threshold. Determining the path error may include a determination of a powered host and a compromised operating system. The path error may be one or more of a switch failure, a host bus adapter failure, a cable failure, and an operating system error.

According to another aspect, a system may include a memory and at least one processor that is operatively coupled to the memory. The at least one processor being configured to perform the operations of providing a storage array having one or more communication paths over a network to a host and determining by the storage array a link-alive command associated with the host. The storage array may detect first link-alive command from the host and a second link-alive command from the host. The storage array may measure a first period between the first and second link-alive commands and define a monitoring threshold based on the first period. The storage array may determine a path error if a second period between two subsequent link-alive commands exceeds the monitoring threshold.

The method may include, alone or in combination, one or more of the following features. Determining the link-alive command may include determining an operating system of the host. Determining the link-alive command may include receiving fabric device management interface (FDMI) data from a switch on the one or more communication paths. The link-alive command may be at least one of an inquiry command or a test unit ready (TUR) command. An alert may be generated when the second period exceeds the monitoring threshold. Determining the path error may include a determination of a powered host and a compromised operating system. The path error may be one or more of a switch failure, a host bus adapter failure, a cable failure, and an operating system error.

According to another aspect, a non-transitory machine-readable medium may encode instructions that when executed by one or more processors cause the one or more processors to perform the operations of providing a storage array having one or more communication paths over a network to a host and determining by the storage array a link-alive command associated with the host. The storage array may detect first link-alive command from the host and a second link-alive command from the host. The storage array may measure a first period between the first and second link-alive commands and define a monitoring threshold based on the first period. The storage array may determine a path error if a second period between two subsequent link-alive commands exceeds the monitoring threshold.

The computer-readable medium may include, alone or in combination, instructions for causing the one or more processors to execute one or more of the following features. Determining the link-alive command may include determining an operating system of the host. Determining the link-alive command may include receiving fabric device management interface (FDMI) data from a switch on the one or more communication paths. The link-alive command may be at least one of an inquiry command or a test unit ready (TUR) command. An alert may be generated when the second period exceeds the monitoring threshold. Determining the path error may include a determination of a powered host and a compromised operating system. The path error may be one or more of a switch failure, a host bus adapter failure, a cable failure, and an operating system error.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a block diagram of an illustrative storage system according to aspects of the present disclosure;

FIG. 2 is a block diagram of a storage system communicatively coupled to a storage array via multiple I/O paths, according to aspects of the present disclosure;

FIG. 3 is a flow diagram illustrating a process for distributed component monitoring, according to embodiments of the present disclosure; and

FIG. 4 is a block diagram of a processing device on which methods and processes disclosed herein can be implemented, according to some embodiments of the disclosure.

### DETAILED DESCRIPTION

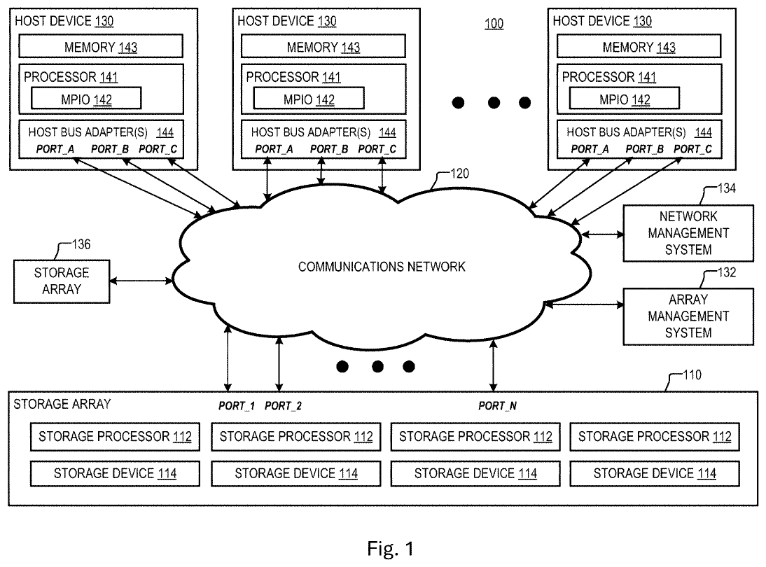

FIG. 1 is a diagram of an example of a storage system 100 for which hardware and software component monitoring may be provided, according to aspects of the disclosure. As illustrated, the system 100 may include a storage array 110, a communications network 120, a plurality of host devices 130, an array management system 132, a network management system 134, and a storage array 136.

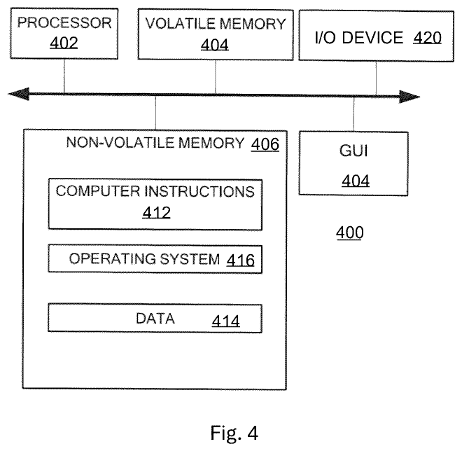

The storage array 110 may include a plurality of storage processors 112 and a plurality of storage devices 114. Each of the storage processors 112 may include a computing device that is configured to receive I/O requests from any of the host devices 130 and execute the received I/O requests by reading or writing data to the storage devices 114. In some implementations, each of the storage processors 112 may have an architecture that is the same or similar to the architecture of the computing device 400 of FIG. 4. The storage processors 112 may be located in the same geographic location or in different geographic locations. Similarly, the storage devices 114 may be located in the same geographic location or different geographic locations. Each of the storage devices 114 may include any of a solid-state drive (SSD), a non-volatile random-access memory (nvRAM) device, a non-volatile memory express (NVME) device, a hard disk (HD), and/or any other suitable type of storage device. In some implementations, the storage devices 114 may be arranged in one or more Redundant Array(s) of Independent Disks (RAID) arrays. The communications network 120 may include one or more of the Internet, a local area network (LAN), a wide area network (WAN), a fibre channel (FC) network, and/or any other suitable type of network.

Each of the host devices 130 may include a laptop, a desktop computer, a smartphone, a tablet, an Internet-of-Things device, and/or any other suitable type of electronic device that is configured to retrieve and store data in the storage arrays 110 and 136. Each host device 130 may include a memory 143, a processor 141, and one or more host bus adapters (HBAs) 144. The memory 143 may include any suitable type of volatile and/or non-volatile memory, such as a solid-state drive (SSD), a hard disk (HD), a random-access memory (RAM), a Synchronous Dynamic Random-Access Memory (SDRAM), etc. The processor 141 may include any suitable type of processing circuitry, such as a general-purpose process (e.g., an x86 processor, a MIPS processor, an ARM processor, etc.), a special-purpose processor, an application-specific integrated circuit (ASIC), a field programmable gate array (FPGA), etc. Each of the HBAs 144 may be a circuit board or integrated circuit adapter that connects a respective one of the host devices 130 to the storage array 110 (and/or storage array 136). In other words, each of the HBAs 144 may include a communications interface for connecting to the communications network 120, storage array 110 and/or storage array 136. Although in the example of FIG. 1 each of the host devices 130 is provided with at least one HBA 144, alternative implementations are possible in which the each of the host devices is provided with another type of communications interface, in addition to (or instead of) an HBA. The other type of communications interface may include one or more of an Ethernet adapter, a WiFi adapter, a local area network (LAN) adapter, etc.

Each processor 141 may be configured to execute a multi-path I/O (MPIO) driver 142. The MPIO driver 142 may comprise, for example, PowerPath TM drivers from Dell EMC TM, and/or other types of MPIO drivers that are arranged to discover available communications paths any of the host devices 130 and the storage array 110. The MPIO driver 142 may be configured to select I/O operations from any of the I/O queues of the host devices 130. The sources of the I/O operations stored in the I/O queues may include respective processes of one or more applications executing on the host devices 130.

The HBA 144 of each of the host devices 130 may include one or more ports. Specifically, in the example of FIG. 1, the HBA 144 of each of the host devices 130 includes three ports, which are herein enumerated as “port A”, “port B”, and “port C”. Furthermore, the storage array 110 may also include a plurality of ports. In the example of FIG. 1, the ports in the storage array 110 are enumerated as “port 1”, “port 2,” and “port N”, where N is a positive integer greater than 2. Each of the ports in the host devices 130 may be coupled to one of the ports of the storage array via a corresponding network path. The corresponding network path may include one or more hops in the communications network 120. Under the nomenclature of the present disclosure, a network path spanning between an HBA port of one of host devices 130 and one of the ports of the storage array 110 is referred to as a “network path of that host device 130”.

Array management system 132 may include a computing device, such as the computing device 400 of FIG. 4. The array management system 132 may be used by a system administrator to re-configure the storage array 110, e.g., when degraded performance of the storage array 110 is detected.

Network management system 134 may include a computing device, such as the computing device 400 of FIG. 4. The network management system 134 may be used by a network administrator to configure the communications network 120 when degraded performance of the communications network 120 is detected.

The storage array 136 may be the same or similar to the storage array 110. The storage array 136 may be configured to store the same data as the storage array 110. The storage array 136 may be configured to operate in either active-active configuration with the storage array 110 or in active-passive configuration. When storage arrays 110 and 136 operate in active-active configuration, a write request to either of storage arrays 110 and 136 is not acknowledged back to the sender until the data associated with the write request is written to both of the storage arrays 110 and 136. When storage arrays 110 and 136 are operated in active-passive configuration, a write request to a given one of the storage arrays 110 and 136 is acknowledge for as long the data associated with write request is written to the given one of the storage arrays 110 and 136 before the writing to the other one of the storage arrays is completed.

While embodiments of the present disclosure are described in terms of storage systems, the structures and techniques disclosed herein may be generally applied to any distributed computing systems.

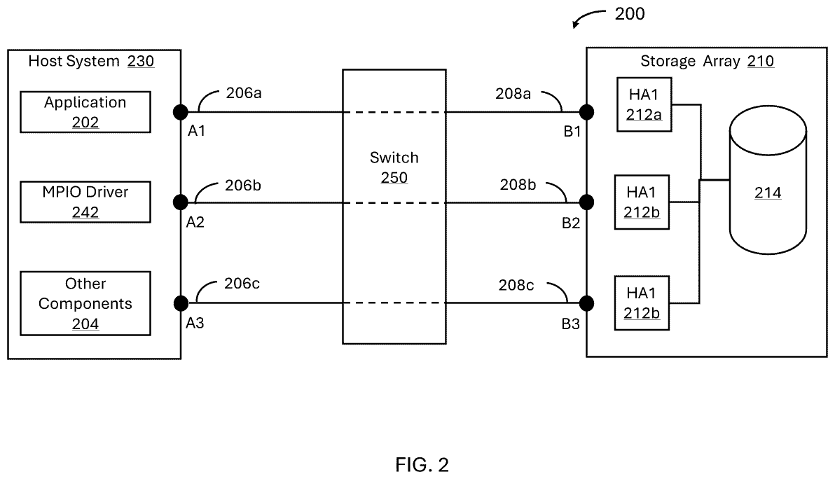

FIG. 2 is a block diagram illustrating an example of a system 200 including a host device or system 230 communicatively coupled to a data storage array 210 via multiple I/O paths, according to one or more aspects of the invention. One skilled in the art will recognize that other aspects of systems including a host system communicatively coupled to a data storage system via multiple I/O paths, for example, variations of system 200, are possible and are intended to fall within the scope of the invention. The system 200 may be implemented using one or more components of the system 100 (FIG. 1), for example, one or more storage arrays 110 and/or one or more host devices 130, or variation thereof.

The system 200 may include a host system 230, switch 250 and data storage array 210. The host system 230 and data storage array 210 may communicate over one or more I/O paths through the switch 250. Elements 206a-206c denote connections between the host system 230 and switch 250. Elements 208a-208c denote connections between the data storage array 210 and the switch 250. Element 214 may represent a physical storage device of the data storage array 220, such as a rotating disk drive, flash-based or other solid state storage device, or the like. It should be noted that in the illustrative example of FIG. 2, the system 200 may include only a single host system 230, a single physical storage device 214, a single data storage system 210, and a single switch 250 for purposes of simplicity to illustrate the techniques herein. For example, multiple host systems having multiple applications executing thereon may communicate with the data storage array 210.

It should be appreciated that the descriptions provided herein may refer to particular examples using the switch 250 having a switching fabric for simplicity of illustration. Element 250 may be a single switch having a switching fabric, or a multi-switch having a multi-switch fabric and the like. Thus, element 250 may more generally denote a network having its own connectivity fabric or network fabric where the network may include one or more components providing the connectivity between the host system 230 and data storage array 210.

The host system 230 may be implemented as a server, and may include one or more applications 202, a multi-path input/output (MPIO) driver 242 and other components 204 such as, for example, one or more other device drivers and other code. According to one aspect, an I/O request (specifying an I/O operation) from the application 202 may be communicated to the data storage array 210 using the MPIO driver 242 and one or more other components 204. The application 202 may be a database or other application which issues data operations, such as I/O operations, to the data storage array 210. Each of the I/O operations may be directed to a target device, such as the physical storage device 214, configured to be accessible to the host system 230 over multiple I/O paths. As such, each of the I/O operations may be forwarded from the application 202 to the data storage array 210 over one of the possible multiple I/O paths.

The MPIO driver 242 may include functionality to perform any one or more different types of processing such as related to encryption, multi-pathing, mirroring, migration, and the like. For example, the MPIO driver 242 may include multi-pathing functionality for management and use of multiple I/O paths. The MPIO driver 242 may perform I/O path selection to select one of the possible multiple I/O paths based on one or more criteria such as load balancing to distribute I/O requests for the target device across available active I/O paths. Load balancing may be performed to provide for better resource utilization and increased performance of the host system, data storage system, and network or other connection infrastructure. The MPIO driver 242 may be included in a commercially available product such as, for example, Dell EMC PowerPath TM software made available by Dell EMC. Other components 204 of the host system 230 may include one or more other layers of software used in connection with communicating the I/O operation from the host system to the data storage array 210 such as, for example, Fibre Channel (FC) or SCSI drivers, a logical volume manager (LVM), or the like. The other components 204 may include software or other components used when sending an I/O operation from the application 202 to the data storage array 210, where such components may include those invoked in a call stack above and/or below the MPIO driver 242. For example, application 202 may issue an I/O operation which is communicated via a call stack including an LVM, the MPIO driver 242, and an FC or SCSI driver.

The data storage array 210 may include one or more physical storage devices, such as physical storage device 214, where each such physical storage device may be configured to store data of one or more logical storage units (LSUs). Each of the LSUs having data stored on the physical storage device 214 may be configured to be accessible to the host system 230 through one or more I/O paths. For example, the LSUs of physical storage device 214 may be accessible using ports of host adapters (HA), for example HA1, HA2 and HA3. The multiple I/O paths allow the application I/Os to be routed over multiple I/O paths and, more generally, allow the LSUs of physical storage device 214 to be accessed over multiple I/O paths. If there is a component failure in one of the multiple I/O paths, I/O requests from applications 202 can be routed over other alternate I/O paths unaffected by the component failure. The MPIO driver 242 may be configured to perform load balancing in connection with I/O path selection, as well as other processing. The MPIO driver 242 may be aware of, and may monitor, all I/O paths between the host system and the physical storage device 214 in order to determine which of the multiple I/O paths are active or available at a point in time, which of the multiple I/O paths are unavailable for communications, and to use such information to select an I/O path for host system-data storage system communications.

In the example of the system 200, the physical storage device 214 may be configured to be accessible through multiple I/O paths, for example to each LSU of the physical storage device 214. Each I/O path may be represented by two path endpoints having a first endpoint on the host system 230 and a second endpoint on the data storage array 210. The first endpoint may correspond to a port of a host system component, such as a host bus adapter (HBA) of the host system 230, and the second endpoint may correspond to a port of a data storage system component, such as a port of an HA of the data storage array 210. In the example of the system 200, elements A1, A2 and A3 each denote a port of a host system 230 (e.g., a port of an HBA), and elements B1, B2 and B3 each denote a port of an HA of the data storage array 210. The physical storage device 214, including the LSUs, may be accessible over three I/O paths—a first IO path represented by A1-B1, a second IO path represented by A2-B2 and a third IO path represented by A3-B3. One skilled in the art will appreciate that additional communication paths may be implemented and the present disclosure is not limited to the three paths shown in FIG. 2.

According to one aspect of the present disclosure, a loss in a communication path between a host system 230 and a storage array 210 may be detected by the storage array 210. As described herein, hosts may be connected to storage array 210s via storage area network (SAN) connectivity, including for example, fiber channel (FC), transmission control protocol (TCP) or the like. The present disclosure may refer to, and describe, aspects with regard to fiber channel storage array 210s (FC SANs), however one skilled in the art will recognize that the same concepts, techniques and methodologies are applicable to all other SANs.

According to aspects of the present disclosure, a storage system user, administrator or monitor may need to be notified when there is a connectivity loss between an initiator, such as a host port, and the storage array 210 port with which it is communicating. Connection losses may be due to any number of failures or errors, including without limitation, a switch failure, a host bus adapter (HBA) failure, a cable failure, an OS crash or the like.

Host OSs and/or MPIO drivers use small computer system interface (SCSI) commands to determine whether a path between a storage array 210 and the host system 230 is still valid. The OS or the MPIO driver sends these commands in fixed intervals that are user defined to validate the path viability. Different OS and MPIO drivers, such as DELL PowerPath, AIX, HP-UX, OpenVMS, Linux, Windows and VMware, may send different commands, including SCSI inquiry or test unit ready (TUR) commands or the like on varying intervals to confirm connection status.

According to one aspect of the disclosure, a storage array, like storage array 210, may detect or determine the host OS from switch fabric device management interface (FDMI) information obtained from the switch 250. The HBA of the host system 230 may query the host itself for the information and send the data to the switch 250. The storage array 210 may then read the FDMI information from the switch on a per-path basis, for example for each initiator-target (I-T) path between an HBA port of the host system 230 and a HA port of the storage array 210.

According to one aspect, the storage array 210 and its processors may be configured such that, upon receiving the FDMI information from the switch 250, the storage array 210 may identify the OS of the host system 230. Accordingly, with the knowledge of what OS the host system 230 may be running, the storage array 210 may further identify one or more link-alive commands used by the host OS to test and verify established connection paths to the storage array 210. As described above, those commands may include inquiry commands, TUR commands, or the like periodically sent by the host system 230 and returned by the storage array 210. According to one aspect of the present disclosure, the storage array 210 may leverage those commands, intended to inform the host system 230 of viable connection paths, to inform itself of path failures.

For example, according to one aspect, the storage array 210 may detect and measure the time between successive link-alive commands. The storage array 210 may identify the link-alive command according to its knowledge of the host OS and determine the host's predetermined period for sending such commands by recording the time at which two successive commands are detected at the storage array 210. Using that period between those received commands, the storage array 210 may set its own threshold for monitoring the arrival of the link-alive commands. The storage array 210 may then monitor incoming link-alive commands and compare the period between subsequent and successive commands determine if the communication path to the host system 230 is still viable.

Accordingly, if a link-alive command is not received according to the period set by the host system 230, and independently measured by the storage array 210, the storage array 210 may determine that the communication path between the HBA port and the storage array 210 port is compromised. For example, if a command is expected but does not arrive, the storage array 210 may understand that the communication path is down. Similarly, if the command is received but it is detected outside of the period, the storage array 210 may know that the communication path is intact but otherwise compromised. Should the storage array 210 determine monitoring period exceeds the threshold, the storage array 210 may generate an error and/or alert to flag a loss in connection path.

According to one aspect, the storage array is able to determine the existence of a viable and working communication path without relying on monitoring read and write commands issued to and from the storage array. Rather than monitor these “last command received” signals to determine a proper connection path, which may require additional resources, the storage array 210 may be able to make the same determination using the link-alive commands the host systems 230 is already sending. Additionally, if there is no read/write activity, that does not necessarily mean that the path is down, as the host system 230 may be idle but still fully connected.

According to one aspect, the storage array may be able to detect that the host system 230 is powered, but the OS is non-functional. For example, rather than using return link service (RLS) or extended link service (ELS) commands, which will return signals if the host system 230 is powered and the HBA is functional, the concepts, technique and methodologies described herein may also be able to detect a non-functioning operating system.

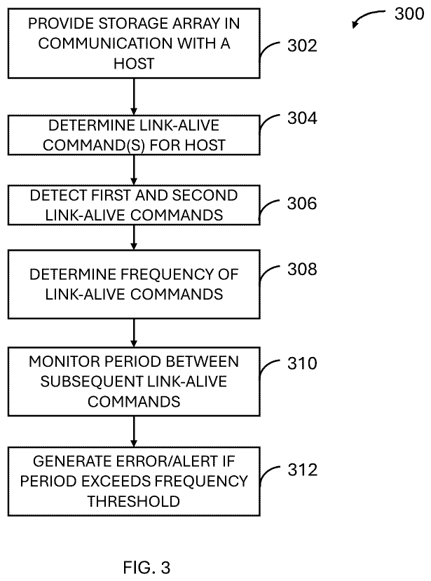

Turning now to FIG. 3, a flow diagram of a method 300 for detecting a path loss between a host system, such as host 130 (FIG. 1) or host system 230 (FIG. 2) and a storage array, such as storage array 110 (FIG. 1) and storage array 210 (FIG. 2) is shown. As described herein, a storage array may be in communication with a host over a network and through a number of components, including a switch, such as switch 250 (FIG. 2), shown in block 302. The storage array may determine, as shown in block 304, on a per-host basis the identity or type of link-alive commands the host may transmit to the storage server. According to one aspect, the storage server may ascertain such information from FDMI data obtained from the switch. Such information may include the host OS and other data indicating the commands (e.g., inquiry or TUR commands) that host employs to test and confirm the viability of a communication path to the storage array.

As shown in block 306, with the knowledge of which link-alive commands the host will be transmitting, the storage array may detect the arrival of two successive link-alive commands from the host. The storage array may measure the time between each of the received link-alive commands and determine the period with which the host is programmed to send out the commands, shown in block 308. This period may be set as a monitoring threshold and, as shown in block 310, the storage array may monitor the system for subsequent commands.

According to one aspect, if link-alive commands are not detected from the host according to the monitoring threshold, the storage array may generate an error and/or an alert indicating that there is the communication path between the host and the storage array is compromised. As detailed herein, the communication path may be caused by one or more of a switch failure, an HBA failure, a cable failure, an OS failure, or the like.

Referring to FIG. 4, in some embodiments, a computing device 400 may include processor 402, volatile memory 404 (e.g., RAM), non-volatile memory 406 (e.g., a hard disk drive, a solid-state drive such as a flash drive, a hybrid magnetic and solid-state drive, etc.), graphical user interface (GUI) 408 (e.g., a touchscreen, a display, and so forth) and input/output (I/O) device 420 (e.g., a mouse, a keyboard, etc.). Non-volatile memory 406 stores computer instructions 412, an operating system 416 and data 418 such that, for example, the computer instructions 412 are executed by the processor 402 out of volatile memory 404.

Program code may be applied to data entered using an input device of GUI 408 or received from I/O device 420.

FIGS. 1-4 are provided as an example only. In some aspects or embodiments, the term “I/O request” or simply “I/O” may be used to refer to an input or output request. In some embodiments, an I/O request may refer to a data read or write request. At least some of the steps discussed with respect to FIGS. 1-6 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used throughout the disclosure, the term “vector” refers to a sequence of numbers (and/or other elements). The phrase “the element having index i” refer to the i-th element in the sequence. For example, if i=1, the phrase i-th element in the sequence would refer to the first element in the sequence, if i=2, the phrase i-th element in the sequence would refer to the second element in the sequence, and so forth.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

What is claimed is:

1. A method comprising:
providing a storage array having one or more communication paths over a network to a host;
determining, by the storage array, a link-alive command associated with the host;
detecting, by the storage array, a first link-alive command from the host;
detecting, by the storage array, a second link-alive command from the host;
measuring, by the storage array, a first period between the first and second link-alive commands;
defining, by the storage array, a monitoring threshold based on the first period; and
determining, by the storage array, a path error if a second period between two subsequent link-alive commands exceeds the monitoring threshold.

2. The method of claim 1 wherein determining the link-alive command includes determining an operating system of the host.

3. The method of claim 1 wherein determining the link-alive command includes receiving fabric device management interface (FDMI) data from a switch on the one or more communication paths.

4. The method of claim 1 wherein the link-alive command is at least one of an inquiry command or a test unit ready (TUR) command.

5. The method of claim 1 further comprising generating an alert when the second period exceeds the monitoring threshold.

6. The method of claim 1 wherein determining the path error includes a determination of a powered host and a compromised operating system.

7. The method of claim 1 wherein the path error is one or more of a switch failure, a host bus adapter failure, a cable failure, and an operating system error.

8. A system comprising:
a memory; and
at least one processor that is operatively coupled to the memory, the at least one processor being configured to perform the operations of:
providing a storage array having one or more communication paths over a network to a host;
determining by the storage array a link-alive command associated with the host;
detecting a first link-alive command from the host;
detecting a second link-alive command from the host;
measuring a first period between the first and second link-alive commands;
defining a monitoring threshold based on the first period; and
determining a path error if a second period between two subsequent link-alive commands exceeds the monitoring threshold.

9. The system of claim 8 wherein determining the link-alive command includes determining an operating system of the host.

10. The system of claim 8 wherein determining the link-alive command includes receiving fabric device management interface (FDMI) data from a switch on the one or more communication paths.

11. The system of claim 8 wherein the link-alive command is at least one of an inquiry command or a test unit ready (TUR) command.

12. The system of claim 8 further comprising generating an alert when the second period exceeds the monitoring threshold.

13. The system of claim 8 wherein determining the path error includes a determination of a powered host and a compromised operating system.

14. The system of claim 8 wherein the path error is one or more of a switch failure, a host bus adapter failure, a cable failure, and an operating system error.

15. A non-transitory machine-readable medium encoding instructions that when executed by one or more processors cause the one or more processors to perform the operations of:
providing a storage array having one or more communication paths over a network to a host;
determining by the storage array a link-alive command associated with the host;
detecting a first link-alive command from the host;
detecting a second link-alive command from the host;
measuring a first period between the first and second link-alive commands;
defining a monitoring threshold based on the first period; and
determining a path error if a second period between two subsequent link-alive commands exceeds the monitoring threshold.

16. The non-transitory machine-readable medium of claim 15 wherein determining the link-alive command includes determining an operating system of the host.

17. The non-transitory machine-readable medium of claim 15 wherein determining the link-alive command includes receiving fabric device management interface (FDMI) data from a switch on the one or more communication paths.

18. The non-transitory machine-readable medium of claim 15 wherein the link-alive command is at least one of an inquiry command or a test unit ready (TUR) command.

19. The non-transitory machine-readable medium of claim 15 wherein the instructions further comprising generating an alert when the second period exceeds the monitoring threshold.

20. The non-transitory machine-readable medium of claim 15 wherein the path error is one or more of a switch failure, a host bus adapter failure, a cable failure, and an operating system error.
